(19) United States
(12) Patent Application Publication
(10) Pub. No.: US 2004/0097219 A1
(43) Pub. Date: May 20, 2004

(54) Communication system with intelligent transceiver

(76) Inventor: Steven K. Lee, Minneapolis, MN (US)

Correspondence Address: Beck & Tysver, P.L.L.C., Suite 100, 2900 Thomas Avenue S., Minneapolis, MN, 55416, US

(21) Appl. No.: 10/435,106

(22) Filed: May 9, 2003

Related U.S. Application Data
(60) Provisional application No. 60/379,649, filed on May 9, 2002.

(51) Int. Cl. H04M 3/00

(52) U.S. Cl. 455/418; 455/420

(57) ABSTRACT

A signal receiver is coupled with data storage and processing capacity to yield a communications system which coordinates signals of varying types with data protocols of varying types and allows data passing through the system to be stored and processed for various purposes.

This application claims priority to provisional application, Ser. No. 60/379,649, filed May 9, 2002.

### FIELD OF THE INVENTION

The present invention relates generally to an intelligent transceiver for receiving, amplifying and transmitting cellular phone signals and other wireless signals. More particularly, this invention relates to an intelligent transceiver in conjunction with data storage and processing capabilities.

### BACKGROUND OF THE INVENTION

Various transmission protocols exist for cellular phone signal transmission. Currently, these include CDMA, TDMA, GSM (at 900 and 1800 MHz); in the near future, cell phone transmissions are expected to follow the GPRS or “3G” protocol which will accommodate both voice and data transmissions. Currently, cellular phone receivers are configured to receive just one such protocol, thereby limiting their flexibility.

Further, cellular phone signals are oftentimes relatively weak, such as in outlying or indoor areas. In particular, cell phone signals are often weak enough that users prefer to use a hard-wired phone when one is present, such as in the user's home or office.

Consumers are accustomed to receiving several types of data transmitted in conjunction with a phone call, such as call log information, caller identification, and TTY. Recently, short message system (SMS) has been widely adopted as a substitute on text pagers. Further, data transmission via email and web access are popular; performing these functions via wireless connections is increasingly popular.

There is a need for a device that can accommodate the reception of wireless or cellular voice and data transmissions according to any protocol, and for the device to translate a received signal into a protocol appropriate for the user's various tools, such as a cell phone, PDA, personal computer or the like. Further, it would be desirable for such a device to amplify the signal intelligently to the appropriate level, particularly the voice signal, so that a strong signal could be transmitted to a user's cell phone inside their home or office.

There is further a need for such a device to have or be coupled to storage, such as a hard drive, so that data and programs can be stored thereon, and so that software operating thereon can manipulate the data received by the device. For example, software might provide voice-to-text conversion, such that a voice message can be transformed into a text message that is then delivered to one or more of the user's tools, such as a computer monitor, a cell phone display, a PDA display or the like.

Various tools for receiving, transmitting and displaying data have evolved including the cellular telephone, wireless personal digital assistants (PDAs) and personal computers. It will be understood that the functions of these devices are continuing to evolve, and the distinctions between devices is blurring, such that in the future it is expected that such tools may vary considerably in function from what is currently identified as a “cellular phone” or “PDA” or “personal computer”. Therefore, such items are referred to herein as “tools” or “communication tools”, and it will be understood that tools perform the function of receiving voice or data transmissions and present the transmission in a manner discernable to a human user, such as by displaying data in a graphical display or by emitting an audible sound or vibration.

### SUMMARY OF THE INVENTION

A signal receiver is coupled with data storage and processing capacity to yield a communications system which coordinates signals of varying types with data protocols of varying types and allows data passing through the system to be stored and processed for various purposes.

### DETAILED DESCRIPTION OF THE PREFERRED EMBODIMENT(S)

The present invention provides a transceiver 1 for receiving wireless data and voice signals from and then transmitting them to a user's cellular phone 5, PDA 6 or other communication tool 7. The transceiver 1 will offer particular advantage to consumers because it will amplify an incoming signal such that their cell phone 5, operating within a predetermined ranged of the transceiver 1, will receive a strong signal.

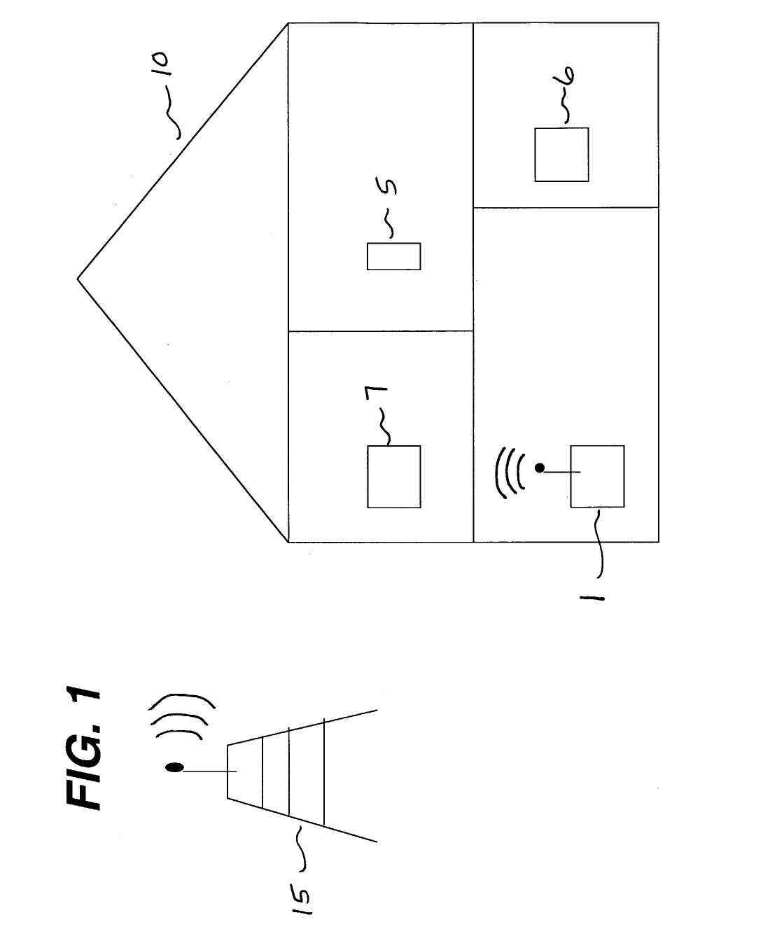

More specifically, the transceiver 1 receives radio signals sent by transmitters 15 in a cellular telephone system. FIG. 1 depicts a transceiver 1 located in a house 10. It will be understood that the transceiver 1 will have application in a variety of other settings. Particular advantage will be achieved in a setting where a cellular phone does not receive particularly good reception, such as on a boat or within a building. Particular advantage will also be achieved in a setting where multiple communication tools are present and have a need to send and receive communications with the world outside of the setting. Generally, though, the transceiver 1 is intended to have a relatively limited range, being able to transmit to devices within a relatively small range, sufficient to reach all communication tools within a house or a few house area (such that neighbors could share one device), or within an office building, such that one device might serve one or more businesses in the building. Limiting the range of the transceiver will reduce interference. If technologies are developed to preclude interference, then the range of an intelligent transceiver 1 might be increased.

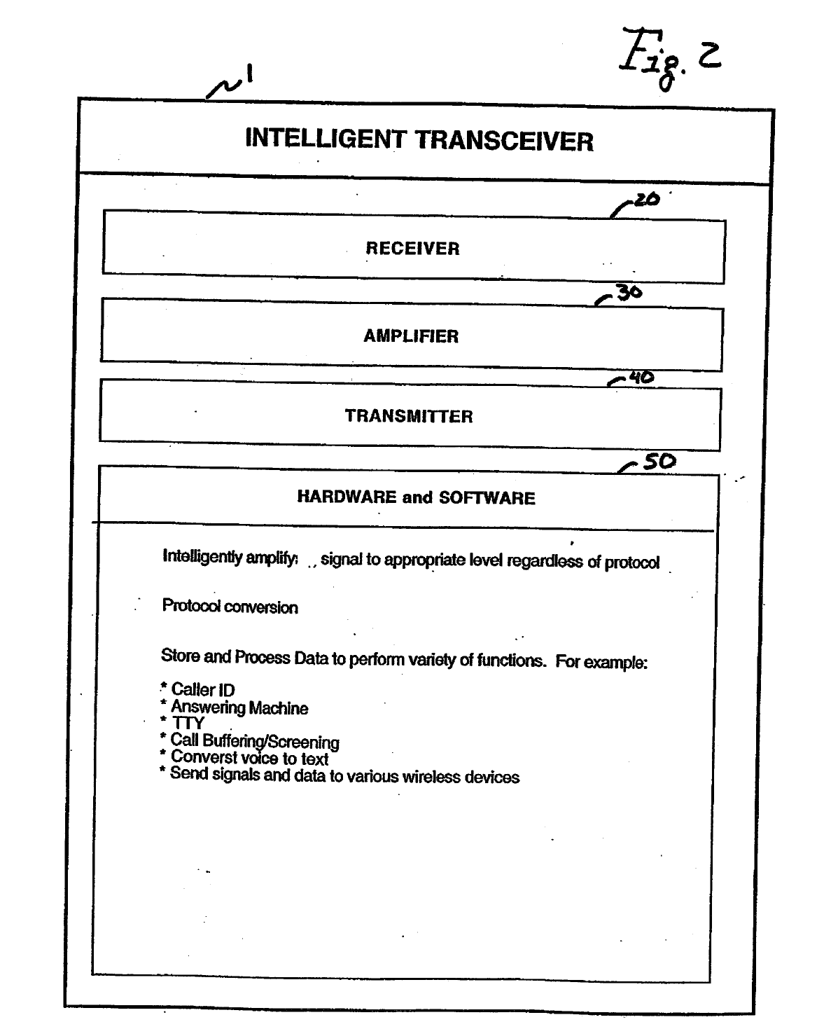

FIG. 2 depicts the desirable components of the transceiver 1. While these components are depicted as separate elements within the transceiver 1, it will be understood that two or more of these elements can be intertwined, such as by residing on a single card bearing integrated circuits, and in such cases would not, therefore necessarily be characterized or conceptualized as separate elements.

The transceiver 1 includes a receiver 20. Preferably, the transceiver 1 is able to receive signals sent via various wireless protocols. Currently, protocols in use include CDMA, TDMA, GSM and, in some countries, GPRS or “3G”. It is expected that the protocols in use will change from time to time and that preferred transceivers 1 will be equipped to handle such protocols.

This transceiver 1 includes or is connected with an amplifier 30 to amplify an incoming signal so that a stronger signal is then transmitted via a transmitter 40 by the transceiver 1 to the user's cellular phone, PDA, or other tool. Preferably the transceiver 1 and its amplifier 30 are “intelligent” and are able to determine the proper amount of signal amplification.

The transceiver 1 includes or is connected to hardware and software 50 for performing a variety of functions and for storing data. As noted above, the amplifier amplifies in an intelligent manner, and this is accomplished via hardware and software. Further, the hardware and software includes a protocol converter for converting or translating one incoming protocol to another. Currently, common protocols include CDMA, TDMA, GSM, WiFi 802.11 x, and 900 MHz DSS. GPRS and/or 3G is expected to become a common protocol. Other protocols may come to exist in the future, and it is anticipated that the transceiver 1 will accommodate protocol conversion involving any such protocol.

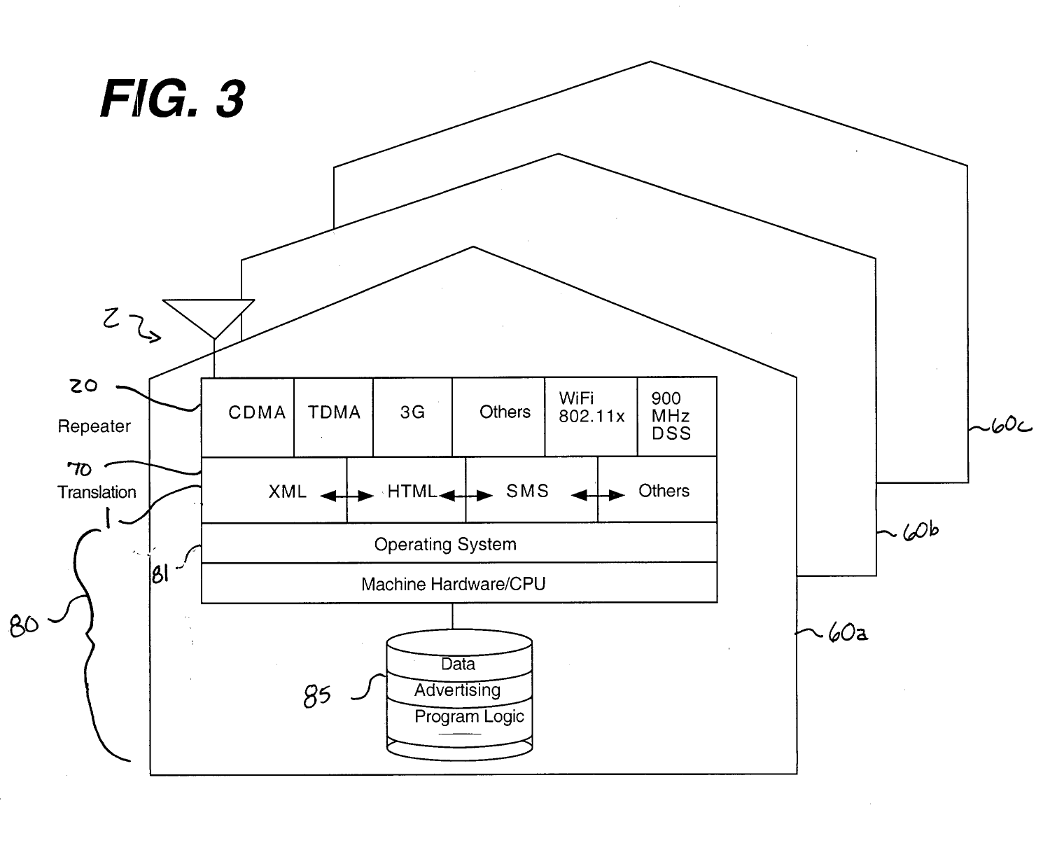

FIG. 3 further illustrates a preferred embodiment of the communication system 2 with an intelligent transceiver 1. FIG. 3 illustrates that the communication system 2 can be shared, via peer-to-peer networking, by several houses in a neighborhood or offices within a building or the like 60a, 60b, 60c. The communication system 2 incorporates receiver hardware 20 for receiving signals of many types. As noted above, signals types currently include via CDMA, TDMA, WiFi 802.11 x, and 900 MHz DSS, and 3G is expected soon. It is contemplated that new types of signals are yet to be developed and it is contemplated that the receiver 20 will accommodate new types of signals as well. The receiver receives and amplifies signals and, in cooperation with a translation layer 70 to which it is linked, transmits the amplified, translated signal to one or more communication tools 5, 6, 7. The translation layer 70 is software and hardware that converts one data protocol into another. Currently, typical data transfer protocols include xml, html, and SMS (short message service). It is expected that other data protocols will be developed and it is contemplated that the translation layer 70 will accommodate such protocols. As an example, if the communication system 2 receives data via the html protocol, the translation layer 70 may translate the data into xml or sms protocol to facilitate the conveyance of the data to a tool 5, 6, 7 that reads xml or sms.

The communication system 2 further incorporates computing hardware and software 80 linked to the receiver 20 and translator 70. The computer 80 has an operating system 81 and storage 85 for data and software. The communication system 2 provides for data received by the receiver 20 to be stored in the computer storage 85. Further the communication system 2 accesses the hard-drive based program logic and other stored information, such that the system 2 can be used not only receive but also to manage and make use of data received.

The hardware and software 50 of the transceiver 1 performs typical telephone functions such as caller identification, call screening, call barring or buffering, TTY, message recording/answering machine functions, call waiting, call forwarding, and so forth. In addition, the hardware and software 50 of the transceiver enables the transceiver to receive a telephone call, recognize the telephone call as being from a predefined phone number, and then perform a predefined action for that telephone call. For example, an advertiser might send an advertising message to the transceiver 1 via a telephone call from a predefined number known to the transceiver 1. The transceiver recognizes the telephone call as being from the predefined number and, according to a predefined response, does not cause the user's telephone to ring. Rather, the call is recorded as data to be processed and stored in storage 85. For example, the advertiser might send a banner ad. The user is not bothered by the incoming call. The transceiver routes the ad to one of the user's communication devices 5, 6, 7 with instructions to store the ad and to insert the ad in a given location, such as to appear on startup or to fill a defined space on a web page.

In another example, a friend of the user might send a calendar entry to the user of the transceiver 1. The transceiver 1 receives the call, recognizes it as a calendar entry, and routes the entry to calendar software on one or more communication tools 5, 6, 7.

This provides just two examples of the possible uses for an intelligent transceiver 1 which is able to receive signals from any protocol, process those signals and intelligently act upon them. The possible uses for such a transceiver 1 are virtually limitless.

It is claimed:

1. A communication system comprising:
a) a receiver capable of receiving a wireless signal;
b) a translation layer coupled to said receiver capable of translating one data protocol to another;
c) a computer coupled to said receiver for storing data received by said receiver.

2. A communication system according to claim 1, wherein said receiver is capable of receiving different kinds of wireless signals;

3. A communication system according to claim 2, wherein said receiver is capable of receiving at least two of the following kinds of signals: CDMA, TDMA, 3G, WiFi 802.11 x and 900 MHz DSS.

4. A communication system according to claim 1, wherein said translation layer is capable of translating from any of the following data protocols to any of the others: XML, HTML, SMS.
